(19) United States
(12) Patent Application Publication
(10) Pub. No.: US 2021/0133540 A1
(43) Pub. Date: May 6, 2021

(54) SYSTEM AND METHOD FOR COMPACT, FAST, AND ACCURATE LSTMS

(71) Applicant: The Trustees of Princeton University, Princeton, NJ (US)

(72) Inventors: Xiaoliang DAI, Princeton, NJ (US); Hongxu YIN, Princeton, NJ (US); Niraj K. JHA, Princeton, NJ (US)

(73) Assignee: The Trustees of Princeton University, Princeton, NJ (US)

(21) Appl. No.: 17/058,428

(22) PCT Filed: Mar. 14, 2019
(86) PCT No.: PCT/US2019/022246

§ 371 Date: Nov. 24, 2020

Related U.S. Application Data
(60) Provisional application No. 62/677,232, filed on May 29, 2018.

(51) Int. Cl. G06N 3/04; G06N 3/063

(52) U.S. Cl. CPC G06N 3/0454; G06N 3/063

(57) ABSTRACT

According to various embodiments, a method for generating an optimal hidden-layer long short-term memory (H-LSTM) architecture is disclosed. The H-LSTM architecture includes a memory cell and a plurality of deep neural network (DNN) control gates enhanced with hidden layers. The method includes providing an initial seed H-LSTM architecture, training the initial seed H-LSTM architecture by growing one or more connections based on gradient information and iteratively pruning one or more connections based on magnitude information, and terminating the iterative pruning when training cannot achieve a predefined accuracy threshold.

### CROSS-REFERENCE TO RELATED APPLICATIONS

This application claims priority to provisional application 62/677,232, filed May 29, 2018, which is herein incorporated by reference in its entirety.

### STATEMENT REGARDING FEDERALLY SPONSORED RESEARCH OR DEVELOPMENT

This invention was made with government support under Grant #CNS-1617640 awarded by the National Science Foundation. The government has certain rights in the invention.

### FIELD OF THE INVENTION

The present invention relates generally to long short-term memory (LSTM) and, more particularly, to a hidden-layer LSTM (H-LSTM) that employs grow-and-prune training to adjust the hidden layers.

### BACKGROUND OF THE INVENTION

Recurrent neural networks (RNNs) have been ubiquitously employed for sequential data modeling due to their ability to carry information through recurrent cycles. However, one common problem for RNN training is the gradient vanishing problem where the gradient values diminish or explode exponentially when time lag increases. Long short-term memory (LSTM) has been proposed as a special type of RNN that uses control gates and cell states to alleviate this problem. It delivers state-of-the-art performance for a wide variety of applications, such as language modeling, speech recognition, image captioning, and neural machine translation. Thus, LSTMs have been applied to a wide spectrum of applications.

Going deeper is a common practice to improve the performance of deep neural networks. Researchers have kept stacking more LSTM cells and increasing the model depth and size to improve accuracy. For example, the DeepSpeech2 architecture, which has been used for speech recognition, contains three convolutional, seven bidirectional recurrent, one fully-connected, and one connectionist temporal classification (CTC) layers. This is more than 2× deeper and 10× larger than the initial DeepSpeech architecture. As another example, the initial LSTM-based neural machine translation model utilizes only four LSTM layers, while its successor, Google's neural machine translation (GNMT) system, possesses eight LSTM layers jointly with additional attention connections.

However, going deeper with LSTM can lead to three common problems that may impact its practicability and ease of usage:

(1) Excessive computation cost: Deployment of a large LSTM model consumes substantial storage, memory bandwidth, and computational resources. Such demands may be too excessive for edge devices, such as mobile phones, smart watches, and Internet-of-Things (IoT) sensors.

(2) Regularization difficulty: Large LSTMs that can easily contain millions of parameters are prone to overfitting but hard to regularize. Employing standard regularization methods that are used for feedforward neural networks (NNs), such as dropout, in an LSTM cell is challenging.

(3) Increased latency: The increasingly stringent runtime latency constraints in real-time applications make large LSTMs, which incur high latency, inapplicable in these scenarios.

At least these problems pose a significant design challenge in obtaining compact, fast, and accurate LSTMs.

### SUMMARY OF THE INVENTION

According to various embodiments, a hidden-layer long short-term memory (H-LSTM) system is disclosed. The system includes a memory cell and a plurality of deep neural network (DNN) control gates enhanced with hidden layers configured to perform a linear transformation followed by an activation function.

According to various embodiments, a method for generating an optimal hidden-layer long short-term memory (H-LSTM) architecture is disclosed. The H-LSTM architecture includes a memory cell and a plurality of deep neural network (DNN) control gates enhanced with hidden layers. The method includes providing an initial seed H-LSTM architecture, training the initial seed H-LSTM architecture by growing one or more connections based on gradient information and iteratively pruning one or more connections based on magnitude information, and terminating the iterative pruning when training cannot achieve a predefined accuracy threshold.

According to various embodiments, a non-transitory computer-readable medium having stored thereon a computer program for execution by a processor configured to perform a method for generating an optimal hidden-layer long short-term memory (H-LSTM) architecture is disclosed. The method includes providing an initial seed H-LSTM architecture, training the initial seed H-LSTM architecture by growing one or more connections based on gradient information and iteratively pruning one or more connections based on magnitude information, and terminating the iterative pruning when training cannot achieve a predefined accuracy threshold.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 depicts a schematic diagram of a general LSTM cell according to an embodiment of the present invention;

FIG. 2 depicts a schematic diagram of a H-LSTM structure according to an embodiment of the present invention;

FIG. 3 depicts flowchart of H-LSTM architecture synthesis flow according to an embodiment of the present invention;

FIG. 4 depicts a diagram of network structure and connection evolution in GP training according to an embodiment of the present invention;

FIG. 5 depicts a methodology for gradient-based growth according to an embodiment of the present invention;

FIG. 6 depicts a methodology for magnitude-based pruning according to an embodiment of the present invention;

FIG. 7 depicts a graph comparing NeuralTalk CIDEr-D for LSTM and H-LSTM cells where number and area indicate size according to an embodiment of the present invention;

FIG. 8 depicts a table showing cell comparison for the NeuralTalk architecture on the MSCOCO dataset according to an embodiment of the present invention;

FIG. 9 depicts a table showing a training methodology comparison according to an embodiment of the present invention;

FIG. 10 depicts a table showing different inference models for the MSCOCO dataset according to an embodiment of the present invention;

FIG. 11 depicts a graph comparing DeepSpeech2 WERs for the GRU, LSTM, and H-LSTM cells where number and area indicate relative size to one LSTM according to an embodiment of the present invention;

FIG. 12 depicts a table showing cell comparison for the DeepSpeech2 architecture on the AN4 dataset according to an embodiment of the present invention;

FIG. 13 depicts a table showing a training methodology comparison according to an embodiment of the present invention;

FIG. 14 depicts a table showing different inference models for the AN4 dataset according to an embodiment of the present invention;

FIG. 15 depicts a table showing GP-trained compact 3-layer H-LSTM DeepSpeech2 model at 10.37% WER according to an embodiment of the present invention;

FIG. 16 depicts a table showing impact of dropout on H-LSTM according to an embodiment of the present invention; and

FIG. 17 depicts a table showing H-LSTM with reduced width for further speedup and compactness according to an embodiment of the present invention.

### DETAILED DESCRIPTION OF THE INVENTION

Long short-term memory (LSTM) has been widely used for sequential data modeling. LSTM depth has typically been increased by stacking LSTM cells to improve performance. However, this incurs model redundancy, increases run-time delay, and makes the LSTMs more prone to overfitting.

To address these problems, generally disclosed herein is a hidden-layer LSTM (H-LSTM) that adds hidden layers to LSTM's one-level nonlinear control gates. H-LSTM increases accuracy while employing fewer external stacked layers, thus reducing the number of parameters and run-time latency significantly. Grow-and-prune (GP) training is employed to iteratively adjust the hidden layers through gradient-based growth and magnitude-based pruning of connections. This learns both the weights and the compact architecture of H-LSTM control gates. The GP training is also augmented with an activation function shift technique. GP-trained H-LSTMs for image captioning and speech recognition applications were created. For the NeuralTalk architecture on the MSCOCO dataset, the created models reduced the number of parameters by 38.7× (floating-point operations (FLOPs) by 45.5×), reduced the run-time latency by 4.5×, and improved the CIDEr-D score by 2.8%. For the DeepSpeech2 architecture on the AN4 dataset, the created models reduced the number of parameters by 19.4× (FLOPs by 23.5×), reduced the run-time latency by 37.4%, and reduced the word error rate from 12.9% to 8.7%. Thus, GP-trained H-LSTMs are more compact, faster, and more accurate than typical models.

LSTM Overview

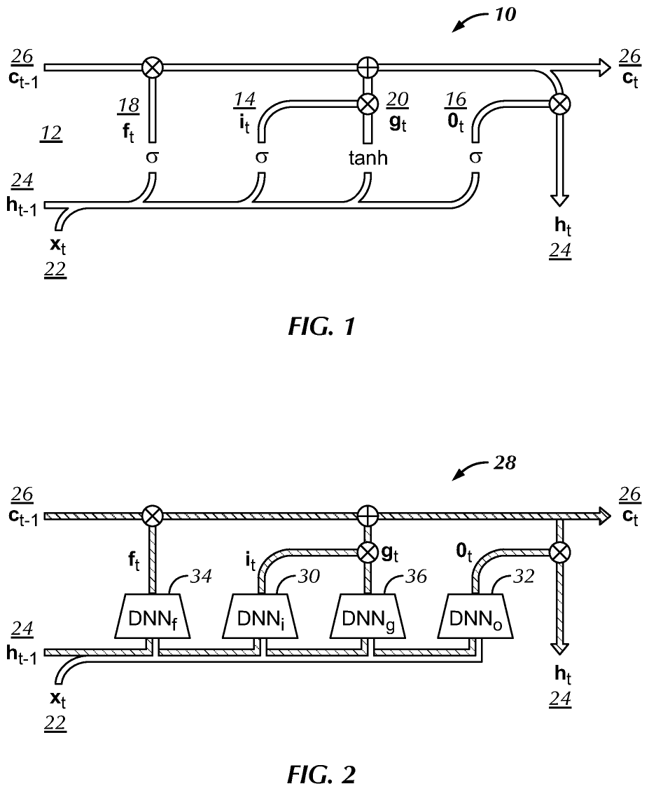

LSTM is a recurrent neural network (RNN) variant that is well-suited for processing, modeling, and making predictions based on time series data. FIG. 1 depicts a schematic diagram of a LSTM cell architecture 10. The LSTM architecture 10 generally includes a memory cell 12 and three control gates (i.e., input gate 14, output gate 16, and forget gate 18). The input gate 14 controls the portion of a new value that flows into the cell 12. The forget gate 18 controls the portion of a value that remains in the cell 12. The output gate 16 controls how the value in the cell 12 is used to compute the output activation of the LSTM unit 10.

The LSTM cell architecture 10 may be implemented in a variety of configurations including general computing devices such as but not limited to desktop computers, laptop computers, tablets, network appliances, and the like. The LSTM cell architecture 10 may also be implemented in mobile devices such as but not limited to a mobile phone, smart phone, smart watch, or tablet computer. The control gates may be implemented in one or more processors such as but not limited to a central processing unit (CPU), a graphics processing unit (GPU), or a field programmable gate array (FPGA).

Computation flow is depicted in Eqs. (1)-(3):

$$\begin{matrix}( \begin{matrix}{f}_{t} \\ {i}_{t} \\ {o}_{t} \\ {g}_{t}\end{matrix} ) = ( \begin{matrix}σ ( {W}_{f} [ {x}_{t} , {h}_{t - 1} ] + {b}_{f} \\ σ ( {W}_{i} [ {x}_{t} , {h}_{t - 1} ] + {b}_{i} \\ σ ( {W}_{o} [ {x}_{t} , {h}_{t - 1} ] + {b}_{o} \\ tanh ( {W}_{g} [ {x}_{t} , {h}_{t - 1} ] + {b}_{g}\end{matrix} ) & ( 1 ) \\ {c}_{t} = {f}_{t} ⊗ {c}_{t - 1} + {i}_{t} ⊗ {g}_{t} & ( 2 ) \\ {h}_{t} = {o}_{t} ⊗ tanh ( {c}_{t} ) & ( 3 )\end{matrix}$$

where fₜ, iₜ, and oₜ refer to the forget gate 18, input gate 14, and output gate 16, respectively. Additionally, gₜ refers to a cell update vector 20, xₜ refers to an input vector 22, hₜ refers to a hidden state vector 24, and cₜ refers to a cell state vector 26. Subscript t refers to step t and subscript t−1 refers to step t−1. W and b refer to weight matrix and bias. σ and tanh refer to the sigmoid and tanh activation functions; ⊗ and ⊕ refer to element-wise multiplication and element-wise addition, respectively.

A major advantage of LSTM relative to a traditional RNN is in its capability to deal with the exploding and vanishing gradient problem during training. The error gradients remain in the LSTM cell when back-propagated from the output layer. This allows the gradient information to flow through time without vanishing, unless cut off by the control gates during training. As a result, LSTMs can learn tasks that require memories of events that happened thousands of discrete time steps earlier. This yields a significant accuracy gain relative to typical RNNs and hence support a wide spectrum of real-world use scenarios.

Hidden-Layer LSTM Overview

Recent years have witnessed the impact of increasing NN depth on its performance. A deep architecture allows an NN to capture low/mid/high-level features through a multi-level information extraction or distillation. Such a hierarchical information distillation process typically leads to a higher inference accuracy. However, since a typical LSTM employs fixed single-layer nonlinearity for gate controls, the current standard approach for increasing model depth is through stacking several LSTM cells or adding deep feed-forward networks externally.

By contrast, embodiments of the present invention employ a different approach that increases depth within LSTM cells. Generally disclosed herein is an H-LSTM architecture whose control gates are enhanced by adding hidden layers. Specifically, a multi-layer transformation is introduced in the three control gates (fₜ 18, iₜ 14, and oₜ 16) and the cell update vector (gₜ 20). H-LSTM focuses on internally deeper control flows, where each control gate is made individually deeper without any network sharing. The introduction of a multi-layer information extraction or distillation in these control gates yields substantial improvements in both model compactness and performance.

FIG. 2 depicts a schematic diagram of a H-LSTM architecture 28. Here, the cell update vector 20 and internal control gates 14-18 are replaced by four deep neural networks (DNNs) with multi-layer transformations. The four DNNs include an input DNN gate 30, output DNN gate 32, forget DNN gate 34, and update DNN gate 36. The update DNN gate 36 controls information flow in the H-LSTM cell.

The internal computation flow is governed by Eqs. (4)-(6):

$$\begin{matrix}( \begin{matrix}{f}_{t} \\ {i}_{t} \\ {o}_{t} \\ {g}_{t}\end{matrix} ) = ( \begin{matrix}{DNN}_{f} ( [ {x}_{t} , {h}_{t - 1} ] ) \\ {DNN}_{i} ( [ {x}_{t} , {h}_{t - 1} ] ) \\ {DNN}_{o} ( [ {x}_{t} , {h}_{t - 1} ] ) \\ {DNN}_{g} ( [ {x}_{t} , {h}_{t - 1} ] )\end{matrix} ) = ( \begin{matrix}σ ( {W}_{f} H * ( [ {x}_{t} , {h}_{t - 1} ] ) + {b}_{f} ) \\ σ ( {W}_{i} H * ( [ {x}_{t} , {h}_{t - 1} ] ) + {b}_{i} ) \\ σ ( {W}_{o} H * ( [ {x}_{t} , {h}_{t - 1} ] ) + o ) \\ tanh ( {W}_{g} H * ( [ {x}_{t} , {h}_{t - 1} ] ) + {b}_{g} )\end{matrix} ) & ( 4 ) \\ {c}_{t} = {f}_{t} ⊗ {c}_{t - 1} + {i}_{t} ⊗ {g}_{t} & ( 5 ) \\ {h}_{t} = {o}_{t} ⊗ tanh ( {c}_{t} ) & ( 6 )\end{matrix}$$

Where DNN and H, respectively, refer to the DNN gates 30-36 and hidden layers (each performs a linear transformation followed by the activation function); * indicates zero or more H layers in the DNN gate.

Introduction of DNN gates provides three major benefits to an H-LSTM:

(1) Strengthened control: Hidden layers in DNN gates enhance gate control through multi-level information extraction or distillation. This makes an H-LSTM more capable and intelligent and alleviates its reliance on external stacking. Consequently, an H-LSTM can achieve comparable or even improved accuracy with fewer external stacked layers relative to a typical LSTM, leading to higher compactness.

(2) Easy regularization: The typical approach only uses dropout in the input/output layers and recurrent connections in the LSTMs. In the embodiments disclosed herein, it becomes possible to apply dropout even to all control gates within an LSTM cell. This reduces overfitting and leads to better generalization.

(3) Flexible gates: Unlike the fixed but specially-crafted gate control functions in LSTMs, DNN gates in an H-LSTM offer a wide range of choices for internal activation functions, such as a rectified linear unit (ReLU). This may provide additional benefits to the model. For example, networks typically learn faster with ReLUs. They can also take advantage of ReLU's zero outputs for FLOPs reduction.

Grow-and-Prune (GP) Training Overview

Typical training based on back propagation on fully-connected NNs yields over-parameterized models. As such, pruning is implemented to drastically reduce the size of large deep convolutional neural networks (CNNs) and LSTMs. The pruning phase is complemented with a brain-inspired growth phase for large CNNs. The network growth phase allows a CNN to grow neurons, connections, and feature maps, as necessary, during training. Thus, it enables automated search in the architecture space. It has been shown that a sequential combination of growth and pruning can yield additional compression on CNNs relative to pruning-only methods (e.g., 1.7× for AlexNet and 2.3× for VGG-16 on top of the pruning-only methods). More detail on GP training can generally be found in PCT Application No. PCT/US18/57485, which is herein incorporated by reference in its entirety.

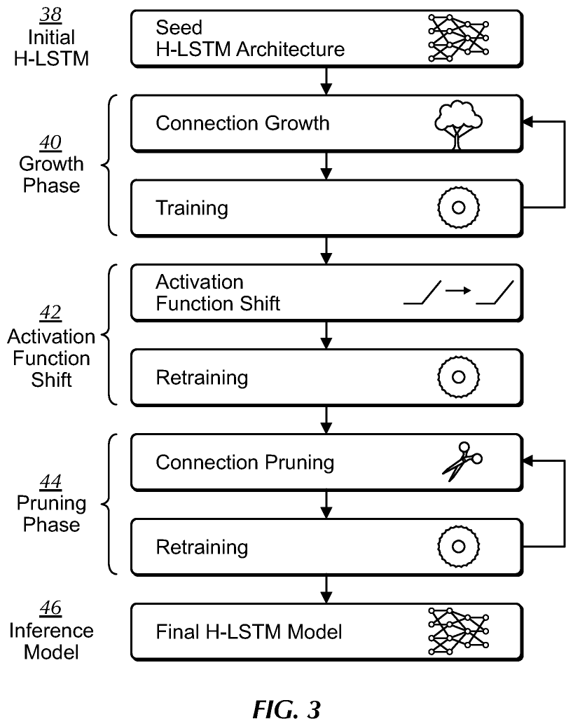

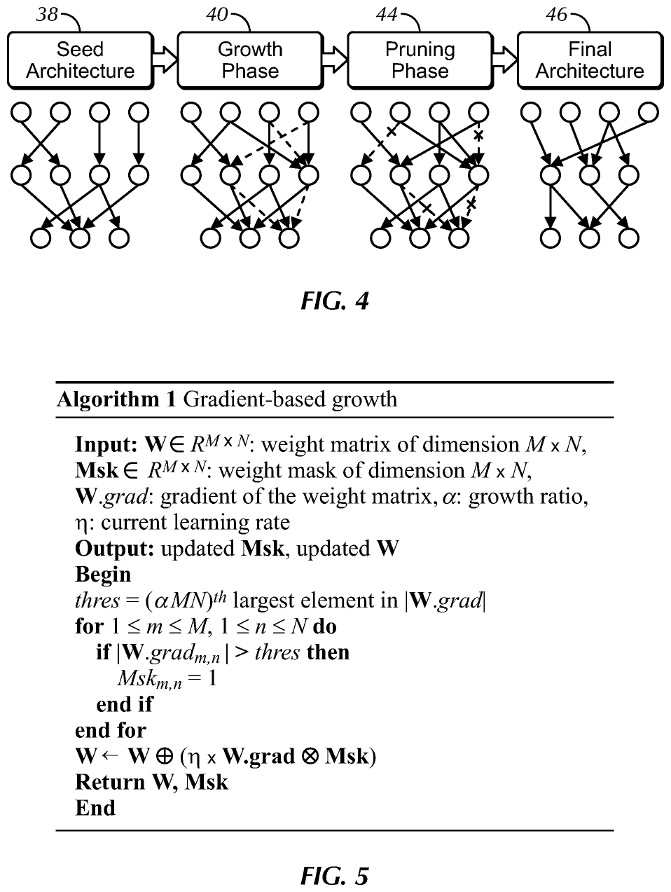

Here, GP training has been extended to LSTMs. The steps involved are depicted in FIG. 3, with network evolution depicted in FIG. 4. GP training starts at step 38 from a randomly initialized sparse seed architecture. The seed architecture contains a very limited fraction of connections to facilitate initial gradient back-propagation. The remaining connections in the matrices are dormant and masked to zero. The flow ensures that all neurons in the network are connected. An initial seed architecture is provided for each DNN in the H-LSTM 28 (e.g. input DNN gate 30, output DNN gate 32, forget DNN gate 34, and update DNN gate 36).

During training, GP training first grows connections based on the gradient information at step 40. After the application of an activation function shift technique at step 42, to be explained in more detail below, GP training prunes away redundant connections for compactness, based on their magnitudes, at step 44. Finally, GP training rests at an accurate, yet compact, inference model at step 46.

GP training adopts the following growth and pruning policies:

Growth policy: Activate a dormant ω in W iff |ω.grad| is larger than the (100α)^{th} percentile of all elements in |W.grad|.

Pruning policy: Remove a ω iff |ω| is smaller than the (100β)^{th} percentile of all elements in |W|.

Here, ω, W, .grad, α, and β refer to the weight of a single connection, weights of all connections within one layer, operation to extract the gradient, growth ratio, and pruning ratio, respectively.

In the growth phase 40, the main objective is to locate the most effective dormant connections to reduce the value of the loss function L. ∂L/∂w is first evaluated for each dormant connection ω based on its average gradient over the entire training set. Then each dormant connection whose gradient magnitude |ω.grad|=|∂L/∂w| surpasses the (100α)^{th} percentile of the gradient magnitudes of its corresponding weight matrix is activated. This rule caters to dormant connections if they provide most efficiency in L reduction. Growth 40 can also help avoid local minima to improve accuracy.

The pruning phase 44 involving the pruning of insignificant weights is an iterative process. In each iteration, insignificant weights whose magnitudes are smaller than the (100β)^{th} percentile within their respective layers are pruned away. A neuron is pruned if all its input (or output) connections are pruned away. The NN is then retrained after weight pruning to recover its performance before starting the next pruning iteration. The pruning phase 44 terminates when retraining cannot achieve a pre-defined accuracy threshold.

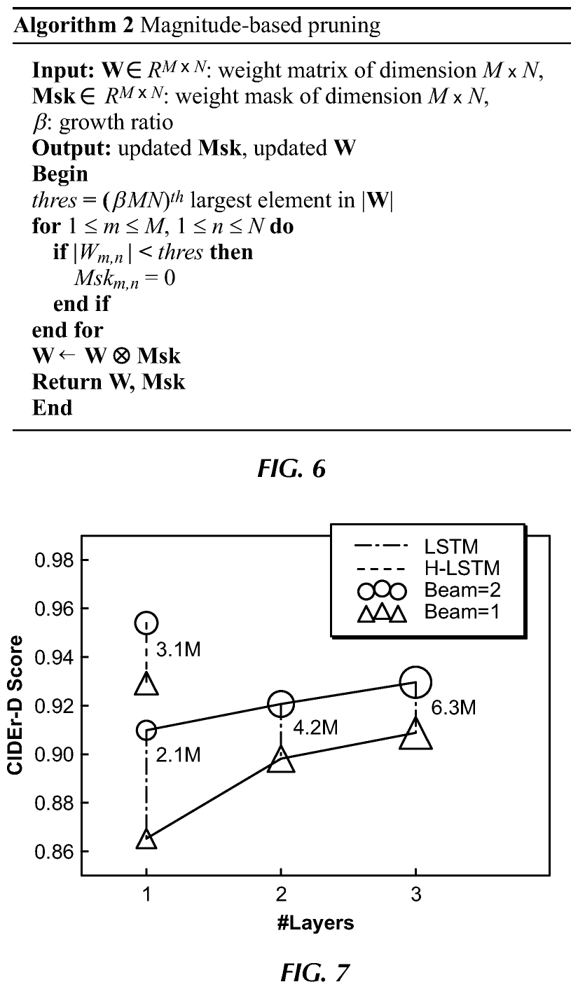

GP training finalizes a model 46 based on the last complete iteration. In one embodiment, a mask Msk is utilized to disregard the ‘dormant’ or pruned connections. It is shown how the mask Msk and weight matrix W is updated in the gradient-based growth and magnitude-based pruning process in the methodology in FIGS. 5 and 6, respectively. Note that this incurs no extra cost in the final inference model since the mask is multiplied into its corresponding weight matrix.

Activation Function Shift

An activation function shift 42 is also employed from a leaky rectified linear unit (ReLU) to a ReLU during training, as shown in FIG. 3. The functions of the leaky ReLU and ReLU are summarized in Eqs. (7) and (8), respectively, where s refers to the reverse slope of the leaky ReLU.

$$\begin{matrix}f ( x ) = \{ \begin{matrix}x if x > 0 \\ sx otherwise\end{matrix} & ( 7 ) \\ f ( x ) = \{ \begin{matrix}x if x > 0 \\ 0 otherwise\end{matrix} & ( 8 )\end{matrix}$$

In the seed architecture 38 and growth phase 40, a leaky ReLU is adopted as the activation function for H * in Eq. (4). A reverse slope s of 0.01 is chosen in one embodiment. Then, for the activation function shift 42, all of the activation functions are changed from leaky ReLU to ReLU while keeping the weights unchanged. This may incur a minor accuracy drop. The network is retrained to recover performance and continue to the pruning phase 44 with ReLU as the activation function.

This activation function shift method brings two major benefits:

(1) The leaky ReLU effectively alleviates the ‘dying ReLU’ phenomenon, in which a zero output of the ReLU neuron blocks it from any future gradient update. Alleviating this phenomenon via reducing the learning rate results in longer training time. Adopting the leaky ReLU in the growth phase allows use of larger learning rate and momentum values, hence enabling faster training.

(2) The ReLU's zero outputs can help reduce FLOPs. Whenever the output value is zero, the corresponding multiply-accumulate operation in the next layer can be bypassed. This may reduce FLOPs by around 15%-20% in some embodiments.

Evaluation of Embodiments of the Disclosed Invention

Results for image captioning and speech recognition benchmarks are presented below. The embodiments were implemented using PyTorch on Nvidia GTX 1060 with 1.708 GHz frequency and Tesla P100 GPUs with 1.329 GHz frequency. CUDA 8.0 and CUDNN 5.1 were also used. It is to be noted none of the implementations or particular application for evaluation are intended to be limiting.

NeuralTalk for Image Captioning:

The effectiveness of embodiments of the disclosed invention is first shown on image captioning.

The NeuralTalk architecture uses the last hidden layer of a pretrained CNN image encoder as an input to a recurrent decoder for sentence generation. The recurrent decoder applies a beam search technique for sentence generation. A beam size of k indicates that at step t, the decoder considers the set of k best sentences obtained so far as candidates to generate sentences in step t+1, and keeps the best k results. In the evaluated embodiment, a VGG-16 is used as the CNN encoder. H-LSTM and LSTM cells are used with the same width of 512 for the recurrent decoder and their performance is compared. Beam=2 is used as the default beam size.

Results are reported on the MSCOCO dataset, which contains 123287 images of size 256×256×3, along with five reference sentences per image. The split used has 113287, 5000, and 5000 images in the training, validation, and test sets, respectively.

W is initialized in the H-LSTM based on a Gaussian distribution with zero mean and 1/\sqrt{n} standard deviation, where n is the dimension of the input vector. In the evaluation, it is determined GP training works better with Gaussian instead of uniform initialization. The same initialization is also adopted for DeepSpeech2, to be discussed further below. An Adam optimizer is used for this evaluation. A batch size of 64 is used for training. The learning rate is initialized to 3×10⁻⁴. In the first 90 epochs, the weights of the CNN are fixed and the LSTM decoder is trained only. The learning rate is decayed by 0.8 factor every six epochs in this phase. After 90 epochs, the CNN and LSTM are fined-tuned at a fixed 1×10⁻⁶ learning rate. A dropout ratio of 0.2 is used for the hidden layers in the H-LSTM. A dropout ratio of 0.5 is also used for the input and output layers of the LSTM. The CIDEr-D score is used for evaluation. It is a variant of the CIDEr score (CIDEr-D is used for MSCOCO as the default server evaluation metric).

The performance of a fully-connected HLSTM is first compared with a fully-connected LSTM to show the benefits emanating from using the H-LSTM cell alone.

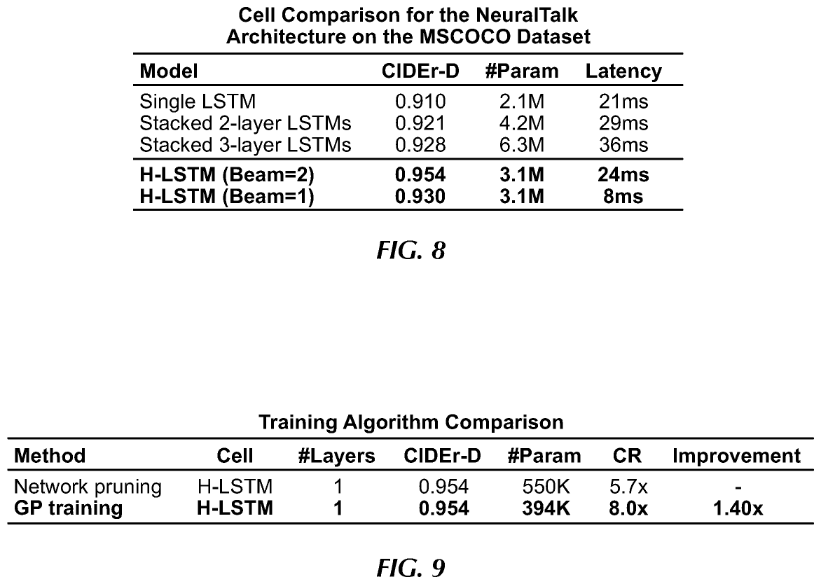

The NeuralTalk architecture with a single LSTM achieves a 0.910 CIDEr-D score. Stacked 2-layer and 3-layer LSTMs are also evaluated, which achieve 0.921 and 0.928 CIDEr-D scores, respectively. A single H-LSTM is trained next and the results are compared in the graph and table in FIGS. 7 and 8, respectively. The single HLSTM achieves a CIDEr-D score of 0.954, which is 4.8%, 3.6%, 2.8% higher than the single LSTM, stacked 2-layer LSTM, and stacked 3-layer LSTM, respectively.

H-LSTM can also reduce run-time latency. Even with Beam=1, a single H-LSTM achieves a higher accuracy than the three LSTM baselines. Reducing the beam size leads to run-time latency reduction. H-LSTM is 4.5×, 3.6×, 2.6× faster than the stacked 3-layer LSTM, stacked 2-layer LSTM, and single LSTM, respectively, while providing higher accuracy.

Next, both network pruning and GP training are implemented to synthesize compact inference models for an H-LSTM (Beam=2). The seed architecture for GP training has a sparsity of 50%. In the growth phase, a 0.8 growth ratio is used in the first five epochs. The results are summarized in the table in FIG. 9, where CR refers to the compression ratio relative to a fully-connected model. GP training provides an additional 1.40× improvement on CR compared with only network pruning.

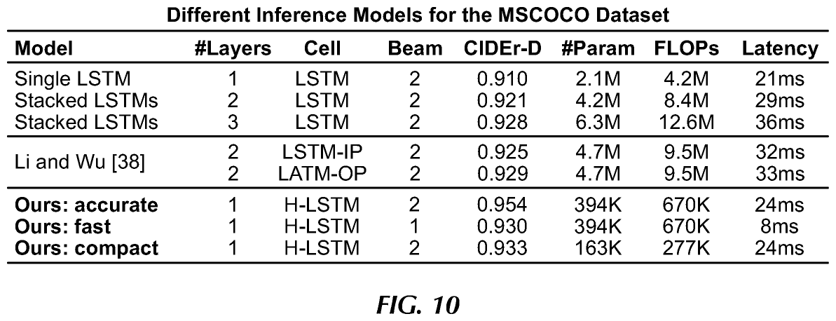

The GP-trained H-LSTM models are listed in the table in FIG. 10. Note that the accurate and fast models are the same network with different beam sizes. The compact model is obtained through further pruning of the accurate model. The stacked 3-layer LSTM is chosen as the baseline due to its high accuracy. H-LSTMs are also compared against LSTMs with input projection (IP) and output projection (OP). The embodiments disclosed herein demonstrate improvements in all aspects (accuracy, speed, and compactness), with a 2.8% higher CIDEr-D score, 4.5× speedup, and 38.7× fewer parameters, respectively.

Note that a beam size of two leads to four evaluation branches per step, i.e. about three times more computation load against beam size one. Thus, the 4:5× speedup of the fast model is a compounded effect of smaller model size and reduced beam size, with 1:5× and 3:0× contributions, respectively.

DeepSpeech2 for Speech Recognition:

Speech recognition is another application also considered.

A bidirectional DeepSpeech2 architecture is implemented that employs stacked recurrent layers following convolutional layers for speech recognition. Mel-frequency cepstral coefficients are used as network inputs, extracted from raw speech data at a 16 KHz sampling rate and 20 ms feature extraction window. There are two CNN layers prior to the recurrent layers and one connectionist temporal classification layer for decoding after the recurrent layers. The width of the hidden and cell states is 800. The width of H-LSTM hidden layers is also set to 800.

The AN4 dataset is used to evaluate the performance of the DeepSpeech2 architecture. It contains 948 training utterances and 130 testing utterances.

A Nesterov SGD optimizer is used in the evaluation. The learning rate is initialized to 3×10⁻⁴, decayed per epoch by a 0.99 factor. A batch size of 16 is used for training. A dropout ratio of 0.2 is used for the hidden layers in the H-LSTM. Batch normalization is applied between recurrent layers. L2 regularization is applied during training with a weight decay of 1×10⁻⁴. A word error rate (WER) is used as the evaluation criterion.

The performance of the fully-connected HLSTM is first compared against the fully-connected LSTM and gate recurrent unit (GRU) to demonstrate the benefits provided by the H-LSTM cell alone. GRU uses reset and update gates for memory control and has fewer parameters than LSTM.

For the baseline, various DeepSpeech2 models containing a different number of stacked layers based on GRU and LSTM cells are trained. The stacked 4-layer and 5-layer GRUs achieve a WER of 14.35% and 11.64%, respectively. The stacked 4-layer and 5-layer LSTMs achieve a WER of 13.99% and 10.56%, respectively.

Next, an H-LSTM is trained to make a comparison. Since an H-LSTM is intrinsically deeper, it is an aim to achieve a similar accuracy with a smaller stack. A WER of 12.44% and 8.92% is reached with stacked 2-layer and 3-layer HLSTMs, respectively.

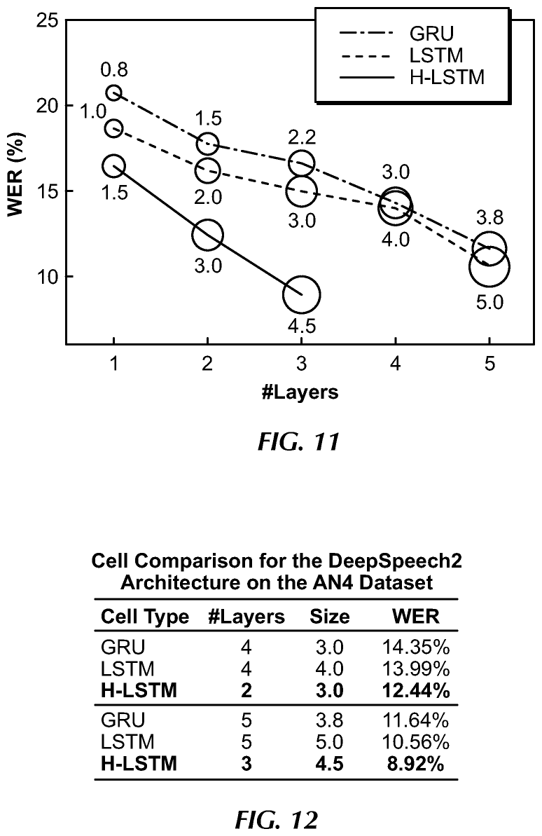

The cell comparison results are summarized in the graph and table in FIGS. 11 and 12, respectively, where all the sizes are normalized to the size of a single LSTM. It is shown that H-LSTM can reduce WER by more than 1.5% with two fewer layers relative to LSTMs and GRUs, thus satisfying initial design goals to stack fewer cells that are individually deeper. H-LSTM models contain fewer parameters for a given target WER, and can achieve lower WER for a given number of parameters.

GP training is next implemented to show its additional benefits on top of just performing network pruning. The stacked 3-layer H-LSTMs is selected for this evaluation due to its highest accuracy. For GP training, the seed architecture is initialized with a connection sparsity of 50%. The networks are grown for three epochs using a 0.9 growth ratio.

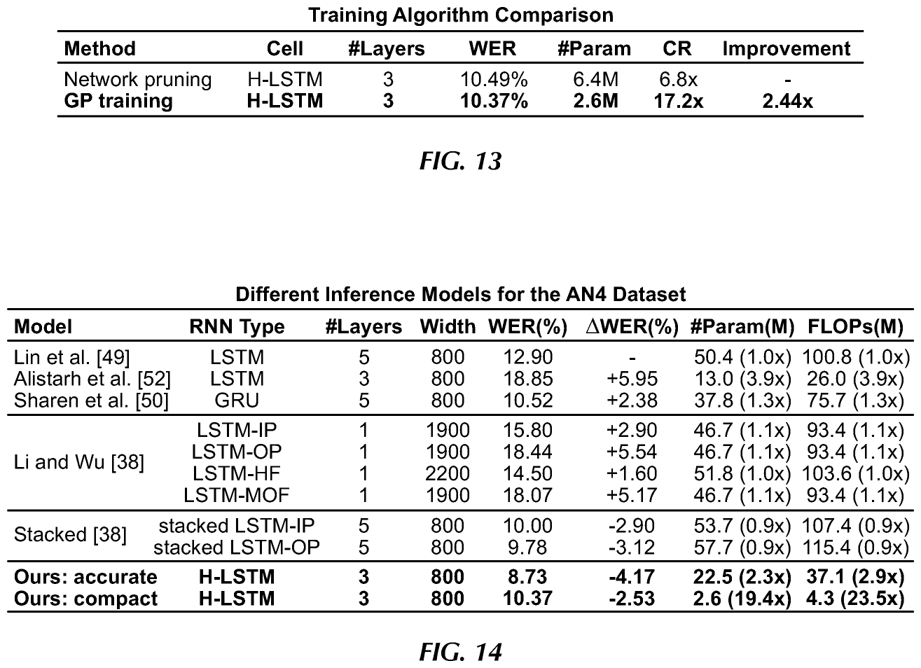

For compactness, an accuracy threshold for both GP training and the pruning-only process is set to 10.52%. These two approaches are compared in the table in FIG. 13. Compared to network pruning only, GP training can further boost the CR by 2.44× while improving the accuracy slightly. This is consistent with prior observations that pruning large CNNs potentially inherits certain redundancies from the original fully connected model that the growth phase can alleviate.

Two GP-trained models are obtained by varying the WER constraint during the pruning phase: an accurate model aimed at a higher accuracy (9.00% WER constraint) and a compact model aimed at extreme compactness (10.52% WER constraint).

The results against other work are compared in the table in FIG. 14. A stacked 5-layer LSTM is selected as the baseline. On top of the substantial parameter and FLOPs reductions, both the accurate and compact models also reduce the average run-time latency from 11.5 ms to 7.2 ms (37.4% reduction) even without any sparse matrix library support. H-LSTMs are also compared against the four LSTM configurations, namely LSTMIP, LSTM-OP, LSTM with input-to-hidden function (LSTMIHF), and LSTM with hidden-to-output function (LSTMHOF) on DeepSpeech2. For all these models, the width of hidden layers is adjusted to achieve a similar model size to the LSTM baseline for a fair comparison. Stacking fewer but deeper H-LSTMs (with or without GP training) outperforms all other methods in both compactness and accuracy.

The introduction of the ReLU activation function in DNN gates provides additional FLOPs reduction for the H-LSTM. This effect does not apply to LSTMs and GRUs that only use tanh and sigmoid gate control functions. At inference time, the average activation percentage of the ReLU outputs is 48.3% for forward-direction LSTMs, and 48.1% for backward-direction LSTMs. This further reduces the overall run-time FLOPs by 14.5%.

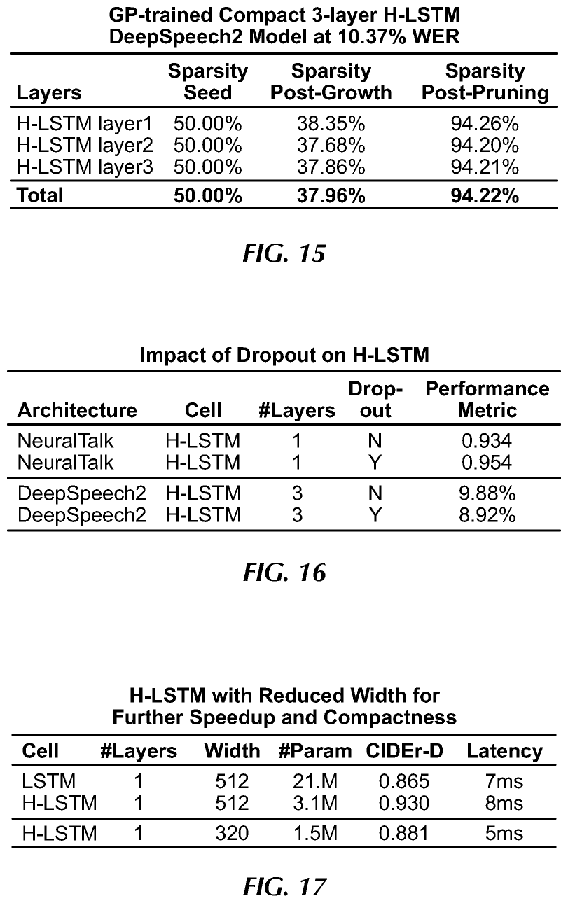

The details of the final inference models are summarized in the table in FIG. 15. The final sparsity of the compact model is as high as 94.22% due to the compounding effect of growth and pruning.

### CONCLUSION

The importance of regularization in H-LSTM is observed on its final performance. The comparison between fully-connected models with and without dropout for both applications is summarized in the table in FIG. 16, where performance metric refers to CIDEr-D score and WER for NeuralTalk and DeepSpeech2, respectively. By appropriately regularizing DNN gates, the CIDEr-D score is improved from 0.934 to 0.954 on NeuralTalk and the WER is reduced from 9.88% to 8.92% on DeepSpeech2.

Some real-time applications may emphasize stringent memory and delay constraints instead of accuracy. In this case, the deployment of stacked LSTMs may be infeasible due to their substantial computation cost. However, the extra parameters in H-LSTM's hidden layers can be easily compensated by a reduced hidden layer and cell state width. Several models for image captioning in the table in FIG. 17, where all the different models share the same beam size of one. If the width of the hidden layers and cell states in the H-LSTM is reduced from 512 to 320, a single-layer H-LSTM can be arrived at that dominates the conventional LSTM from all three design perspectives. This coincides with general neural network training where slimmer but deeper NNs (in this case H-LSTM with reduced hidden layer and cell state width) normally exhibit better performance than shallower but wider NNs (in this case LSTM).

As such, embodiments disclosed herein combine H-LSTM and GP training to learn compact, fast, and accurate LSTMs. An H-LSTM adds hidden layers to control gates as opposed to architectures that just employ a one-level nonlinearity. GP training combines gradient-based growth and magnitude-based pruning to ensure H-LSTM compactness. An activation function shift technique is also incorporated to improve the training behavior as well as to reduce FLOPs. H-LSTMs were GP-trained for image captioning and speech recognition applications. For the NeuralTalk architecture on the MSCOCO dataset, disclosed embodiments reduced the number of parameters by 38.7× (FLOPs by 45.5×) and run-time latency by 4.5×, and improved the CIDEr-D score by 2.8%. For the DeepSpeech2 architecture on the AN4 dataset, disclosed embodiments reduced the number of parameters by 19.4× (FLOPs by 23.5×), run-time latency by 37.4%, and WER from 12.9% to 8.7%.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

1. A hidden-layer long short-term memory (H-LSTM) system comprising:
a memory cell; and
a plurality of deep neural network (DNN) control gates, each control gate having at least one hidden layer configured to perform a linear transformation followed by an activation function.

2. The H-LSTM system of claim 1, wherein the plurality of DNN control gates comprises an input DNN gate configured to control a portion of a new value that flows into the memory cell.

3. The H-LSTM system of claim 1, wherein the plurality of DNN control gates comprises an output DNN gate configured to control how value in the memory cell is used to compute output activation of the H-LSTM system.

4. The H-LSTM system of claim 1, wherein the plurality of DNN control gates comprises a forget DNN control gate configured to control a portion of a value that remains in the memory cell.

5. The H-LSTM system of claim 1, wherein the plurality of DNN control gates comprises an update DNN gate configured to control information flow in the memory cell.

6. The H-LSTM system of claim 1, wherein the plurality of DNN control gates are trained via a gradient-based growth phase and a magnitude-based pruning phase.

7. The H-LSTM system of claim 6, wherein the gradient-based growth phase is based on a policy to add connections whose gradient magnitude surpasses a predefined percentile of gradient magnitudes based on a growth ratio.

8. The H-LSTM system of claim 6, wherein the magnitude-based pruning phase is based on a policy to remove connections whose magnitudes are smaller than a predefined percentile of magnitudes based on a pruning ratio.

9. The H-LSTM system of claim 6, wherein the magnitude-based pruning phase is iterative, being terminated when training cannot achieve a predefined accuracy threshold.

10. The H-LSTM system of claim 6, wherein the plurality of DNN control gates are further trained via an activation function shift.

11. The H-LSTM system of claim 10, wherein the activation function shift comprises a shift from a leaky rectified linear unit (ReLU) in the gradient-based growth phase to a ReLU in the magnitude-based pruning phase.

12. A method for generating an optimal hidden-layer long short-term memory (H-LSTM) architecture, the H-LSTM architecture including a memory cell and a plurality of deep neural network (DNN) control gates, each control gate having at least one hidden layer, the method comprising:
providing an initial seed H-LSTM architecture;
training the initial seed H-LSTM architecture by growing one or more connections based on gradient information and iteratively pruning one or more connections based on magnitude information; and
terminating the iterative pruning when training cannot achieve a predefined accuracy threshold.

13. The method of claim 12, wherein growing connections is based on a policy to add connections whose gradient magnitude surpasses a predefined percentile of gradient magnitudes based on a growth ratio.

14. The method of claim 12, wherein iteratively pruning connections is based on a policy to remove connections whose magnitudes are smaller than a predefined percentile of magnitudes based on a pruning ratio.

15. The method of claim 12, further comprising shifting an activation function.

16. The method of claim 15, wherein shifting the activation function comprises shifting from a leaky rectified linear unit (ReLU) when growing connections to a ReLU when pruning connections.

17. (canceled)

18. (canceled)

19. (canceled)

20. (canceled)

21. A non-transitory computer-readable medium having stored thereon a computer program for execution by a processor configured to perform a method for generating an optimal hidden-layer long short-term memory (H-LSTM) architecture, the H-LSTM architecture including a memory cell and a plurality of deep neural network (DNN) control gates, each control gate having at least one hidden layer, the method comprising:
providing an initial seed H-LSTM architecture;
training the initial seed H-LSTM architecture by growing one or more connections based on gradient information and iteratively pruning one or more connections based on magnitude information; and
terminating the iterative pruning when training cannot achieve a predefined accuracy threshold.

22. The computer-readable medium of claim 21, wherein growing connections is based on a policy to add connections whose gradient magnitude surpasses a predefined percentile of gradient magnitudes based on a growth ratio.

23. The computer-readable medium of claim 21, wherein iteratively pruning connections is based on a policy to remove connections whose magnitudes are smaller than a predefined percentile of magnitudes based on a pruning ratio.

24. The computer-readable medium of claim 21, wherein the method further comprises shifting an activation function.

25. The computer-readable medium of claim 24, wherein shifting the activation function comprises shifting from a leaky rectified linear unit (ReLU) when growing connections to a ReLU when pruning connections.
